(19) United States
(12) Patent Application Publication
(10) Pub. No.: US 2026/0271884 A1
(43) Pub. Date: Sep. 17, 2026

(54) MODULAR ANIMAL COLLAR SYSTEM WITH INTERCHANGEABLE ATTACHMENTS

(71) Applicant: Tristan Quade-Mitchell Oberlin, St Petersburg, FL (US)

(72) Inventor: Tristan Quade-Mitchell Oberlin, St Petersburg, FL (US)

(21) Appl. No.: 19/560,793

(22) Filed: Mar. 9, 2026

Related U.S. Application Data
(60) Provisional application No. 63/769,890, filed on Mar. 11, 2025.

(51) Int. Cl. A01K 27/00

(52) U.S. Cl. CPC A01K 27/001; A01K 27/007

(57) ABSTRACT

A modular animal collar system comprising a base collar with a continuous loop-compatible fastening surface and a reusable external attachment having a hook-fastening underside. The attachment features a flush-edge interface that aligns vertically with the collar edge to resist torsional peeling when engaged with the loop-compatible fastening surface of the collar. The attachment includes a rigid terminal tip to facilitate insertion beneath leash-attachment hardware and a multi-functional terminal loop tab. The tab serves as a tactile purchase point for peeling removal and as a mechanical latch to secure the attachment in a compacted storage roll with the hook surface facing outward.

### CROSS-REFERENCE TO RELATED APPLICATIONS

This application claims priority to the U.S. Provisional Patent Application No. 63/769,890, filed on Mar. 11, 2025, the entire contents of which are incorporated herein by reference.

### FIELD

The present invention relates generally to animal accessories and, more particularly, to a modular animal collar system including a base collar and one or more removable attachments configured for releasable engagement with the base collar or another loop-compatible surface. In certain embodiments, the system may include flush-edge engagement geometry and optional storage configurations for organizing multiple attachments.

### BACKGROUND

Domestic animals, such as dogs, commonly wear collars for identification, leash attachment, and decorative purposes. Conventional collars are typically manufactured as a single integrated structure, requiring the entire collar to be replaced when a different appearance, seasonal design, or decorative style is desired. This can lead to unnecessary expense, material waste, and inconvenience for the user.

Attempts have been made to provide interchangeable or decorative collar covers intended to allow a user to change the outward appearance of a collar without replacing the entire collar. For example, U.S. Patent Application Publication No. 2010/0269765 (Barghahn) describes a removable cover configured to fit over an existing collar. While such systems provide some level of interchangeability, certain configurations may present practical limitations.

In some prior designs, removable covers may extend beyond the width of the underlying collar, which can result in exposed edges that are susceptible to peeling, twisting, or separation during normal use. In other cases, removable covers may interfere with leash-attachment hardware, such as D-rings or similar connectors, making installation difficult or reducing reliability when the collar is under tension. Additionally, prior systems may not provide a convenient structure for storing, organizing, or repeatedly using multiple removable decorative elements.

Accordingly, there remains a need for a modular animal collar system that allows decorative or thematic changes without requiring replacement of the entire collar, while maintaining secure attachment, compatibility with leash hardware, and convenient storage and reuse of removable components.

### SUMMARY

The present invention addresses these and other needs by providing a collar system including a base collar having an outward-facing loop-compatible fastening surface and a removable external attachment configured to engage the fastening surface. In certain embodiments, the attachment may form a flush-edge interface that resists torsional peeling when engaged with the fastening surface. In some embodiments, the attachment may include a terminal reinforcement member that facilitates insertion beneath hardware. In further embodiments, the attachment may include a multi-functional handling tab. In still further embodiments, the attachment may be configurable for storage, enabling a transition between a planar hanging mode and a rolled storage configuration.

### BRIEF DESCRIPTION OF THE DRAWINGS

FIG. 1 is a perspective view of the modular animal collar system in a fully deployed state on an animal.

FIG. 2 is an isometric view of the underside of the removable external attachment.

FIG. 3 is a perspective view of the removable external attachment in a Compacted Storage Mode, illustrating the strip being rolled with the hook-fastening surface facing outward.

FIG. 4 is a perspective view of the system illustrating the peeling utility of the terminal loop tab.

FIG. 5 is a perspective view of the system in a stiffened hanging mode, illustrating two attachments nested back-to-back.

FIG. 6 is a cross-sectional view taken along the width of the attachment, illustrating the flush-edge interface.

FIG. 7 is an exploded cross-sectional view of the removable external attachment, illustrating the multi-layer laminate assembly and integrated functional zone.

### DETAILED DESCRIPTION

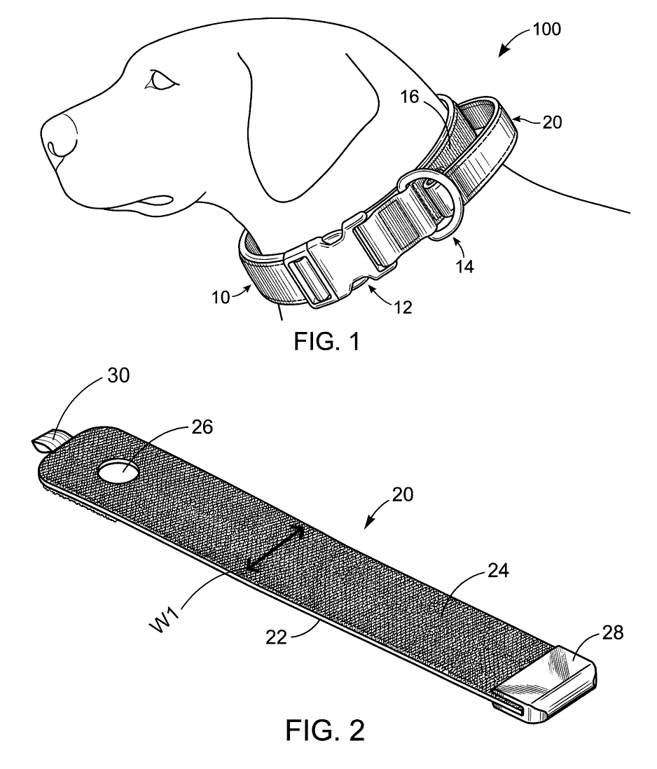

Referring to FIG. 1, a modular animal collar system 100 is illustrated in a fully deployed state on an animal. The system comprises a base collar 10 having a primary buckle segment 12 and a leash-attachment hardware 14, such as a D-ring, for leash attachment. The exterior surface of the base collar 10 comprises a continuous loop-compatible fastening surface 16. A removable external attachment 20 is secured to the loop-compatible fastening surface 16. As shown, the attachment 20 routes beneath the leash-attachment hardware 14. Specifically, in certain embodiments, the total thickness of the attachment 20 is less than an interior clearance of the leash-attachment hardware 14, such that the attachment may be threaded through the hardware while the leash-attachment hardware remains fully accessible for leash engagement without interference.

FIG. 2 illustrates the underside of the removable external attachment 20. The attachment comprises an elongate, flexible strip body 22 having a hook-fastening surface 24 disposed along substantially the entire length of its underside. A transverse aperture 26 extends through the thickness of the strip. At a distal end, in some embodiments, the attachment features a terminal reinforcement member 28, which may be constructed from a rigid metal tip, rubberized cap, or stiffened polymer dip. This reinforcement member 28 is configured to facilitate insertion through the leash-attachment hardware 14 (shown in FIG. 1) without the flexible material bunching or buckling.

Still referring to FIG. 2, the attachment includes a terminal loop tab 30 extending from a longitudinal end of the strip body 22. The strip body 22 has a defined width W1 that is substantially co-extensive with the width of the base collar to form a flush-edge interface, as discussed further in FIG. 6.

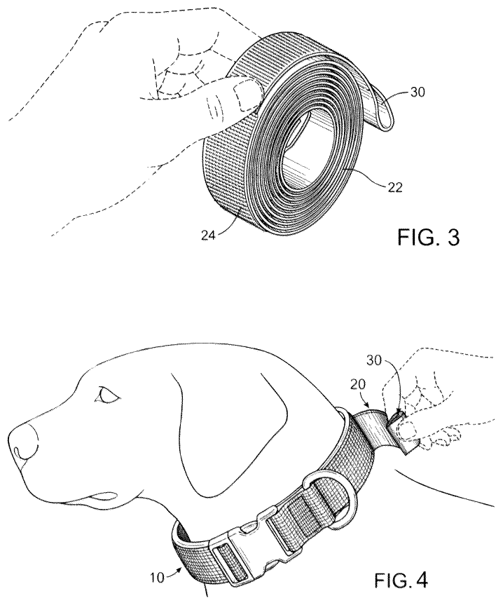

FIG. 3 illustrates the Compacted Storage Mode. To transition to this mode, the user rolls the flexible strip body 22 longitudinally into a spiral configuration. In this embodiment, the strip is rolled with the hook-fastening surface 24 facing outward. This configuration may increase the available surface area for latching; the terminal loop tab 30 is pressed against the exposed hook-fastening surface 24 to act as a mechanical latch at any point along the circumference of the roll. This may allow the user to selectively adjust the tightness and diameter of the storage cylinder at a plurality of positions along the circumference of the roll.

FIG. 4 demonstrates the deployment utility of the terminal loop tab 30. When the attachment 20 is secured to the base collar 10, the loop tab 30 provides a tactile purchase point. The user grasps the tab 30 to initiate a peeling action, progressively disengaging the hook-fastening surface from the loop-compatible fastening surface. This may reduce the need for the user to pick at the edges of the strip with fingernails, protecting the edge integrity.

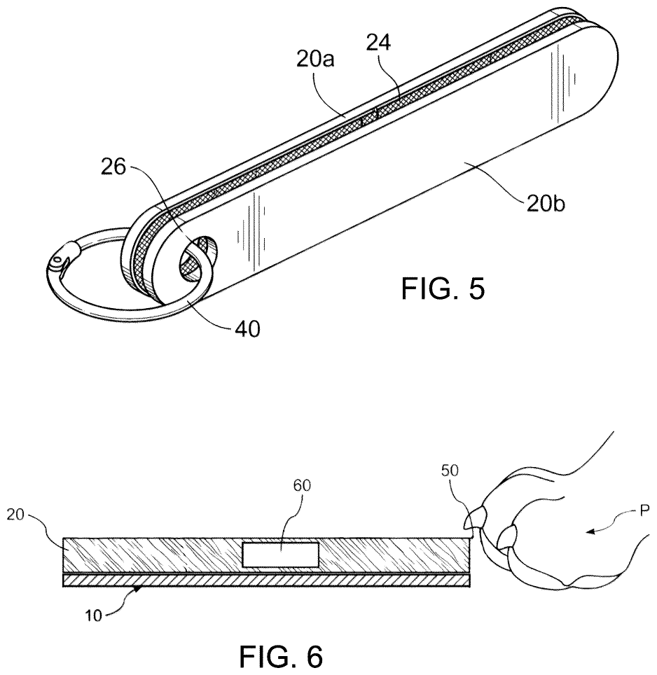

FIG. 5 illustrates the Stiffened Hanging Mode. Two identical attachments 20a and 20b are placed back-to-back such that their respective hook-fastening surfaces 24 face one another. In this configuration, the transverse apertures 26 of both strips are coaxially aligned to create a single through-hole. A secondary retention device 40 (e.g., a binder ring, tether, or utility hook) interacts with the aligned apertures to maintain the attachments in a nested, organized stack.

FIG. 6 is a cross-sectional view taken along the width of the attachment 20. The flush-edge interface 50 is clearly visible, where the edge of the attachment 20 terminates in substantial vertical alignment with the edge of the base collar 10. In some embodiments, the attachment 20 may include an integrated functional zone 60 depicted here as a bioactive carrier matrix infused, impregnated, or sewn directly into the flexible material. This configuration allows the attachment to act as an optional passive delivery system for time-released substances, such as calming pheromones, pest repellents, or deodorizing agents, while maintaining a low profile that may reduce the ability of an animal's paw (P) to gain leverage to peel the strip.

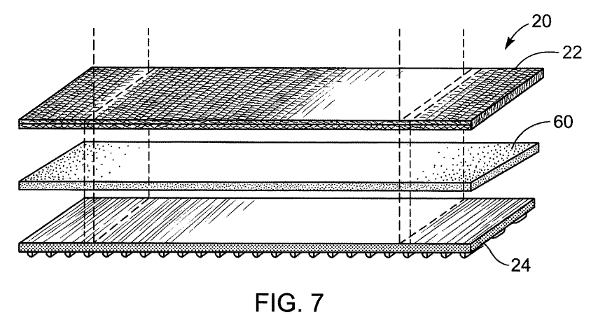

FIG. 7 provides an exploded cross-sectional view of the multi-layer laminate assembly of the attachment 20. The assembly comprises a top decorative webbing layer 22, a bottom hook-fastening layer 24, and the integrated functional zone 60 (bioactive carrier matrix) disposed therebetween. The layers are joined by stitching that is recessed from the lateral edges of the assembly, creating a secure internal pocket that encapsulates the functional zone 60. This recessed stitching may restrict the functional components within the assembly, resisting lateral shifting while maintaining the clean profile of the flush-edge interface.

1. A modular animal collar system comprising: a base collar configured for independent wear by an animal, the base collar having an outward-facing loop-compatible fastening surface; and a removable external attachment separate from the base collar, the removable external attachment comprising an elongate, flexible strip having a hook fastening surface disposed along substantially an entire underside; wherein the flexible strip has a width substantially co-extensive with a width of the loop-compatible fastening surface to form a flush-edge interface that resists torsional peeling when engaged with the loop-compatible fastening surface.

2. The system of claim 1, wherein the removable external attachment further comprises a terminal loop tab disposed on an exterior side of the strip.

3. The system of claim 2, wherein the terminal loop tab is a multi-functional handling member configured to: (a) provide a tactile purchase point for the progressive disengagement of the hook fastening surface from the base collar while the collar is secured about an animal; and (b) serve as a mechanical latch to retain the removable external attachment in a compacted storage mode.

4. The system of claim 3, wherein the removable external attachment is transitionable into said compacted storage mode characterized by the strip being rolled longitudinally into a spiral configuration with the hook fastening surface facing outward, such that the hook fastening surface engages the terminal loop tab to retain the spiral.

5. The system of claim 4, wherein the terminal loop tab is configured to engage the outward-facing hook surface at a plurality of positions, thereby allowing the removable external attachment to be self-secured at varying volumetric diameters without the need for auxiliary retention bands.

6. The system of claim 2, wherein the removable external attachment is transitionable into a stiffened hanging mode comprising at least two removable external attachments joined back-to-back via their respective hook fastening surfaces such that their respective transverse apertures are coaxially aligned.

7. The system of claim 6, wherein the coaxially aligned transverse apertures are configured to receive a secondary retention device selected from a binder ring or a tether to maintain the at least two removable external attachments in a nested, sequential order.

8. The system of claim 1, wherein the loop-compatible fastening surface extends continuously along substantially the entire exterior length of the base collar, thereby providing an uninterrupted engagement zone for the removable external attachment.

9. The system of claim 1, wherein the loop-compatible fastening surface extends across at least a portion of a buckle strap segment of the base collar.

10. The system of claim 1, wherein the removable external attachment is configured as a modular unit transferable between a first base collar and a second base collar of the same or different length.

11. The system of claim 1, wherein the removable external attachment further comprises a bound edge, hem, or sealed perimeter configured to resist fraying of the flexible strip.

12. The system of claim 1, wherein an end portion of the removable external attachment includes a terminal reinforcement member comprising a distinct material rigidity relative to the flexible strip, selected from a metal tip, a rubberized cap, a polymer dip, or a stitched fold.

13. The system of claim 12, wherein the terminal reinforcement member provides sufficient structural rigidity to facilitate the insertion of the attachment beneath leash-attachment hardware of the base collar without buckling or deformation of the flexible strip.

14. The system of claim 1, wherein the removable external attachment is configured to be selectively applied to or removed from the base collar regardless of whether the base collar is currently secured about an animal.

15. A method of managing a modular animal accessory system, the method comprising: progressively pressing a flexible attachment strip having a hook-fastening underside onto an exterior loop-compatible surface of a base collar; removing the flexible attachment strip by grasping a terminal loop tab to peel the strip away from the base collar; and transitioning the flexible attachment strip to a storage state selected from a rolled configuration with hooks facing outward (secured by the terminal loop tab) or a back-to-back configuration in which apertures are aligned for hanging or tethering to a plurality of additional attachments.

16. The system of claim 1, wherein the removable external attachment is impregnated with, or comprises a carrier matrix for, a bioactive or aromatic substance selected from a pest repellent, a calming pheromone, or a deodorizing agent configured for time-released diffusion.

17. The system of claim 1, wherein the exterior side of the removable external attachment comprises a hydrophobic or oleophobic coating configured to resist moisture and debris accumulation.

18. The system of claim 1, wherein the removable external attachment is further configured for engagement with a loop-compatible fastening surface disposed on a leash, such that a plurality of removable external attachments may be temporarily secured to the leash for storage or transport.

19. A modular storage kit for animal accessories, comprising: a plurality of removable external attachments according to claim 2; and a secondary retention device configured to pass through the coaxially aligned transverse apertures of the plurality of attachments when said attachments are in a back-to-back configuration to maintain the plurality of attachments in a nested, sequential order.

20. The system of claim 1, wherein the base collar further comprises leash-attachment hardware, and wherein the removable external attachment is configured to pass beneath the leash-attachment hardware while remaining engaged with the loop-compatible fastening surface such that the leash-attachment hardware remains usable for leash connection.
